(19) United States
(12) Patent Application Publication
(10) Pub. No.: US 2012/0132496 A1
(43) Pub. Date: May 31, 2012

(54) BEARING TYPE OVERRUNNING CLUTCH STRUCTURE

(75) Inventor: Juhua Chen, Fujian (CN)

(73) Assignee: Xiamen Chengde Intellectual Property Law Firm, Fujian (CN)

(21) Appl. No.: 13/381,667

(22) PCT Filed: Dec. 6, 2010
(86) PCT No.: PCT/CN10/01970

§ 371 Date: Feb. 13, 2012

(30) Foreign Application Priority Data
Dec. 11, 2009 (CN) 200920265245.1
Sep. 16, 2010 (CN) 201010293311.3

(51) Int. Cl. F16D 41/066

(52) U.S. Cl. 192/45.004

(57) ABSTRACT

A bearing type overrunning clutch includes an outer ring (1) and an inner star wheel (2). A plurality of rollers (3) are provided between the outer ring (1) and the inner star wheel (2). A plurality of concave grooves are provided on the outer cylindrical surface of the inner star wheel (2), each of which corresponds to one roller (3) respectively. The clearance between the adjacent rollers (3) is 0 to 0.2 mm. The main characteristic of the invention is to ensure the clearance between the adjacent rollers (3) to be in the range of 0 to 2 mm by increasing the number of rollers in a same space; at the same time, to increase the contact strength by providing the plurality of concave grooves on the outer cylindrical surface of the inner star wheel (2). The invention has advantages of reasonable structure design, simple manufacturing process, high manufacturing accuracy and strong working reliability, etc. The overrunning clutch according to the invention can bear relatively large torque and impact force, and can work for a long time under a circumstance of high speed and heavy load.

### BACKGROUND OF THE INVENTION

The present invention relates to a bearing-type overrunning clutch structure, pertaining to the field of clutch manufacturing technology according to the international patent classification (IPC), and more particularly to a novel overrunning clutch structure of a loader biaxial assembly.

An overrunning clutch, also called a one-way clutch or one-way bearing, is a device that can only transmit power towards one rotating direction. When the speed of an active raceway is the same as that of a passive raceway, the power is transmitted. When the speed of the active raceway is lower than that of the passive raceway, the passive raceway rotates freely.

The current overrunning clutch mainly includes two types, that is, a roller-type overrunning clutch and a wedge-type overrunning clutch. The overrunning clutch is an extremely important part of a loader gearbox assembly. Nowadays, most loader gearbox assemblies adopt the traditional roller-type overrunning clutch. The roller-type overrunning clutch structure is generally formed by an inner-ring cam, a roller, a cylindrical spring, a spacer ring, a gland cover, and other elements. When the clutch is engaged, due to structural restriction and synchronization, the number of rollers that work effectively is reduced, and a working plane of the inner-ring cam of the clutch linearly contacts the rollers, and thus the surface compressive stress quickly becomes excessively large which results in an arc pit, and meanwhile, a friction angle increases quickly, which results in slipping and failure of the clutch. China Patent No. CN2708031 has disclosed an overrunning clutch, which comprises an outer ring, a star wheel, a roller, and an elasticity device which is installed in a hole on the side of the star wheel tooth and impels the roller to glide on the star wheel; it further comprises a sliding block, which glides on the star wheel with the roller and combines with the inner wall of the outer ring under the impulse of the elasticity device. In addition, China Patent No. CN101629606 has disclosed a multi-roller overrunning clutch, comprising at least six rollers, an outer ring of inner star wheel type, a retainer, and spring pieces with its number the same as that of the rollers. The retainer is tightly fitted in the outer ring of inner star wheel type; the rollers are placed in each window formed by an end ring and a beam and at each concave curved wedge surface in the outer ring of inner star wheel type; one end of the spring piece is provided with an elastic bayonet, and the other end is an arc-shaped end which matches with the outer circle surface of each roller; the elastic bayonet of the spring piece is buckled on the beam of the retainer; and the arc-shaped end matches with the roller and pushes the roller tightly. As restricted by their structures, the above two types of roller-type overrunning clutches have a low bearing capability and cannot work synchronously; these become their critical problems.

However, the wedge-type overrunning clutch also has defects in technology. For example, the applicant of the present invention has filed a patent application No. 03102580.3, titled Double Holding Frame Overdrive Clutch on Dec. 13, 2003, which has disclosed a double holding frame overrunning clutch, comprising an internal ring with an external slide way, an external ring with an internal slide way, multiple allotypic jamming blocks being arranged between the internal and external slide ways, and an annular twin holder consisting of internal and external holders. The internal and external holders are equally distributed with the same number of retaining holes. The allotypic jamming blocks are retained in the internal and external slide ways by means of the retaining holes of the twin holder. The twin holder has multiple perforated elastic bands equally distributed between the internal holders and the external holders, for inserting the jamming blocks into the holes of the elastic bands. The external holder is provided with multiple fixed reeds and the internal holder is provided with multiple friction reeds. Although the above overrunning clutch ensures synchronization work, the wedge block has a small curvature radius, and the clearance between the holder and the wedge block is quite large. Thus, the wedge block is easily tilted when being loaded, rendering a point-contact between the wedge block and the internal/external slide way, so the torque borne becomes small.

### BRIEF SUMMARY OF THE INVENTION

In view of the defects of the clutch technology in the prior art, the present invention is directed to a bearing-type overrunning clutch structure, which has a higher bearing capability and a longer service life.

To achieve the above object, the present invention employs the following technical solutions.

The present invention provides a bearing-type overrunning clutch structure, which comprises an outer ring, an inner star wheel, and a plurality of rollers provided between the outer ring and the inner star wheel.

A plurality of concave curved grooves are provided on an outer cylindrical surface of the inner star wheel along its peripheral direction. Each of the concave curved grooves corresponds to one roller respectively. An outer raceway of the rollers is an inner cylindrical surface of the outer ring which contacts the roller, and an inner raceway of the rollers is the concave curved grooves on the outer cylindrical surface of the inner star wheel.

The inner star wheel and the outer ring rotate relative to each other in the same direction; when a speed n2 of the inner star wheel is lower than or equal to a speed n1 of the outer ring, the rollers are wedged tightly between the inner star wheel and the outer ring, and in this case, the clutch is in engaging status; when the speed n2 of the inner star wheel is larger than the speed n1 of the outer ring, the clutch is in disengaging status.

Furthermore, the outer ring is a gear-type outer ring, provided with an annular groove along its peripheral direction. The inner star wheel and multiple rollers matching with the inner star wheel are disposed in the annular groove to form a clutch structure. Each of the rollers is installed in a corresponding concave curved groove on the outer cylindrical surface of the inner star wheel. The outer raceway of the rollers is an external peripheral surface of the annular groove at the outer ring, and the inner raceway of the rollers is the concave curved groove on the inner star wheel.

Furthermore, a clearance between adjacent rollers in the bearing-type overrunning clutch is s=a−2r=0-0.2 mm, in which a is the central distance between adjacent rollers, and r is the radius of the roller.

When the clutch is in engaging status, one roller is engaged and loaded, and then all the rollers are synchronously loaded through interlocking between the rollers, thereby ensuring overall synchronization during working.

Furthermore, the concave curved grooves are equidistantly distributed on the outer cylindrical surface of the inner star wheel. The concave curved grooves have a depth L, which is d/10<L<d/2, in which d indicates a diameter of the roller (if the depth is insufficient, it is difficult to loosen the clutch, and if the depth is excessive, it is difficult to manufacture the concave curved grooves).

Furthermore, a generating line of a concave curved surface for forming the concave curved grooves is parallel to an axis of the inner star wheel.

Furthermore, the concave curved surface in the concave curved grooves is formed from a logarithmic spiral or arc.

Furthermore, an eccentric distance e from a polar point of the logarithmic spiral or a circle center of the arc for forming the concave curved surface to a center of the roller satisfies: e>0.

Furthermore, the rollers are tangent to an outer raceway surface of the gear-type outer ring or to the outer ring.

According to the present invention, when a speed n2 of the inner star wheel is lower than or equal to a speed n1 of the outer ring, the rollers are wedged tightly between the inner star wheel and the outer ring, and the clutch is in engaging status. When the speed n2 of the inner star wheel is larger than the speed n1 of the outer ring, the clutch is in disengaging status.

The present invention has the following features: the number of rollers increases within the same accommodation space of the bearing-type overrunning clutch; the clearance between two adjacent rollers is reduced to 0-0.2 mm; and a plane shape of the inner star wheel in the prior art is changed to a concave curved surface shape. This design has the following advantages:

1. The bearing capability of the clutch is enhanced: The spring plunger mechanism or three-feet spring and the retainer of the overrunning clutch in the prior art are removed in the bearing-type overrunning clutch according to the present invention, thereby avoiding failure of the spring and the plunger and over-wearing or distortion of the rollers caused when the number of rollers working efficiently decreases, and preventing the rollers from being tilted due to the larger clearance between the retainer and the roller when being loaded so as to solve the problem that the bearing capability is deteriorated as the rollers and the star wheel/the outer ring maintain a point contact. According to the present invention, the number of rollers in the same space is increased and the clearance between the rollers is reduced, and a plane shape of the inner star wheel as in the prior art is changed into a concave curved surface shape to increase the comprehensive curvature at the contact point between the rollers and the external surface of the inner star wheel, thereby greatly increasing the contact strength and the torque capacity.

2. Overall synchronization of the clutch is realized: The clearance between adjacent rollers is s=0-0.2 mm. When the clutch is in engaging status, one roller is engaged and loaded, and then all rollers are synchronously loaded through interlocking between the rollers, thereby ensuring overall synchronization of the clutch during working.

Thus, compared with the overrunning clutch in the prior art regarding the same space, the structure according to the present invention has a reasonable structural design, simple manufacturing process, strong working reliability, and high synchronization, which can bear larger torque and impact force, and can work for a long time under a high speed and a heavy load.

The bearing-type overrunning clutch structure according to the present invention is mainly applicable to loaders, and further applicable to airplanes, tanks, military trucks, heavy duty trucks, off-road vehicles, ships, fork lift trucks, cars, motorcycles, lathes, printing mechanics, textile mechanics, nut former machines, spring machines, intermittent transmission mechanics between different product lines, mining mechanics, wrenches, and so on.

### BRIEF DESCRIPTION OF THE DRAWINGS

FIG. 1 is a partial cross-sectional view according to the present invention;

FIG. 2 is a partial cross-sectional view of a bearing-type overrunning dutch of a loader biaxial assembly for working status analysis;

FIG. 3 is a partial cross-sectional view of the bearing-type overrunning dutch of a loader biaxial assembly for angle analysis; and

FIG. 4 is a side sectional view of a clutch according to another embodiment of the present invention.

### LIST OF THE PARTS

| | |
|---|---|
| 1 | Outer ring |
| 2 | Inner star wheel |
| 20 | Concave curved groove |
| 3 | Roller |
| 4 | Rotating shaft |
| 40 | End cover of rotating shaft |
| 5 | Bolt |

### DETAILED DESCRIPTION OF THE INVENTION

The present invention is further described below with reference to the accompanying drawings.

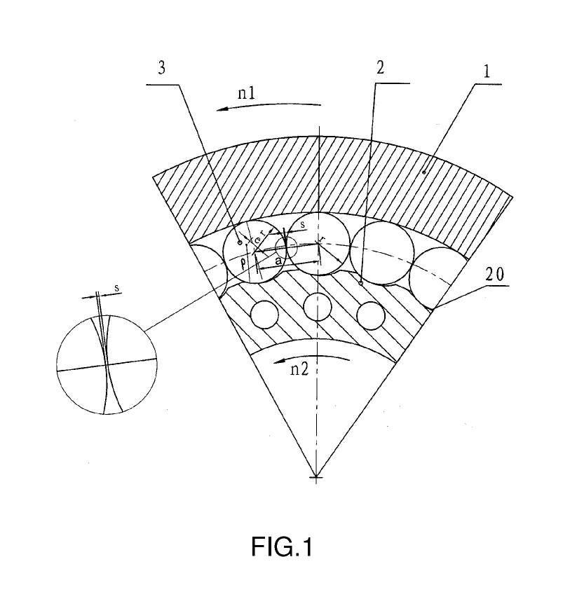

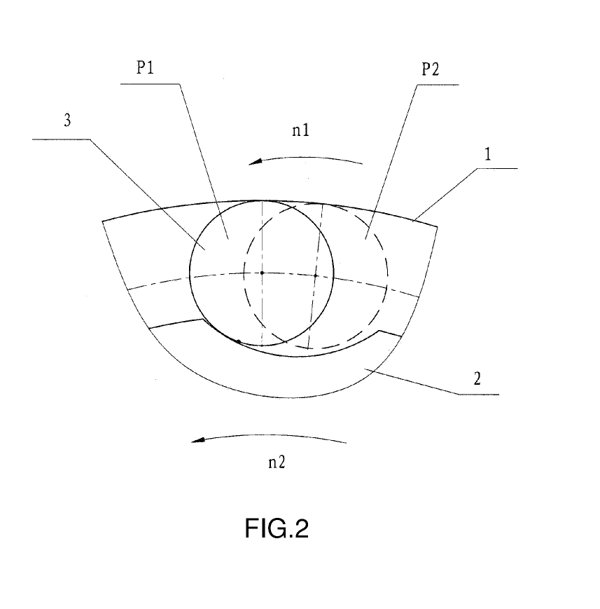

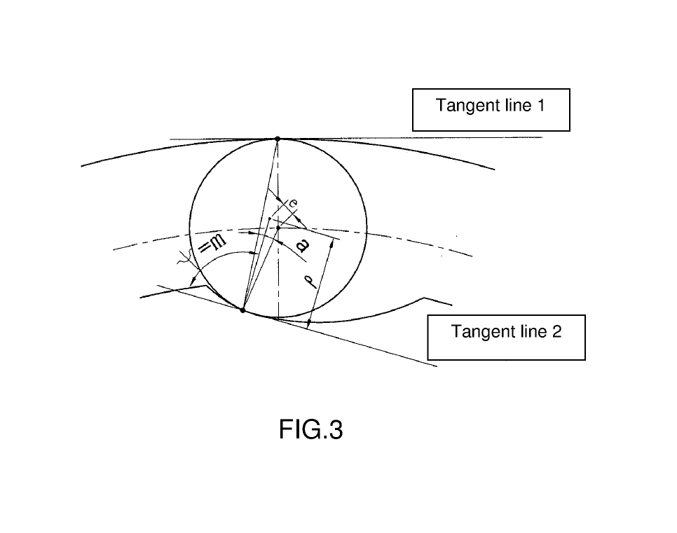

Referring to FIG. 1, a bearing-type overrunning clutch applied in a loader is also called a bearing-type overrunning clutch of a loader biaxial assembly, which comprises an outer ring 1, an inner star wheel 2, and a plurality of rollers 3. Twenty-four rollers 3 are disposed between the outer ring 1 and the inner star wheel 2; twenty-four concave curved grooves are disposed on an outer cylindrical surface of the inner star wheel 2, each of the concave curved grooves corresponding to a roller 3 respectively. As shown in FIG. 3, a concave curved surface in the concave curved groove is formed in logarithmic spirals. Since an included angle ψ (i.e., spiral angle) between a tangent line at any point of the logarithmic spiral and a polar radius ρ at this point is a constant m, the rollers, from engaging instantaneously to sufficiently transmitting torque, maintain a constant engagement angle α relative to the inner raceway, and thus the force applied on each roller is equal. As shown in FIG. 2, when the inner star wheel 2 rotates anticlockwise and the speed n2 of the inner star wheel 2 is lower than or equal to the speed n1 of the outer ring 1, the rollers are engaged. The inner star wheel 2 drives the outer ring 1 to rotate through the rollers 3, and the clutch is in engaging status P1, as indicated by the solid line shown in FIG. 2. When the speed n2 of the inner star wheel 2 is larger than the speed n1 of the outer ring 1, the clutch is in disengaging status P2, as indicated by the dotted line shown in FIG. 2.

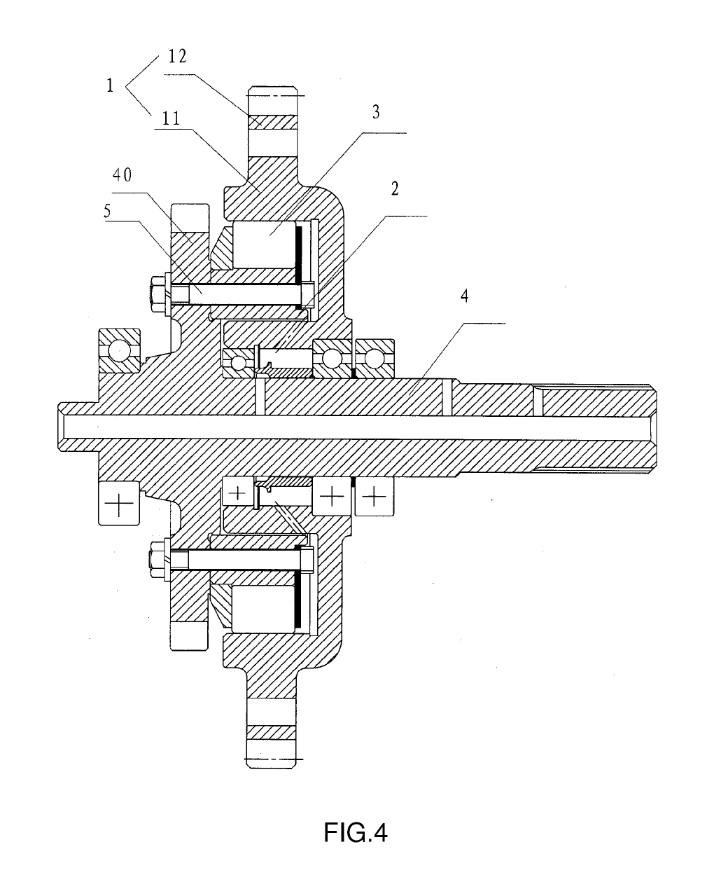

FIG. 4 shows a bearing-type overrunning clutch structure, in which the outer ring 1 is a gear-type outer ring, and is formed by a ring body 11 and a plurality of gear teeth 12 disposed at the external peripheral edge thereof. The ring body 11 is provided with an annular groove along its peripheral direction, and the notch of the annular groove passes through an end surface of the gear-type outer ring. The inner star wheel 2 and a plurality of rollers 3 matching with the inner star wheel 2 are disposed in the annular groove to form a clutch structure. Each of the rollers is installed in a corresponding concave curved groove on the outer cylindrical surface of the inner star wheel. The outer raceway of the rollers is the external peripheral surface of the annular concave groove at the outer ring, and the inner raceway of the rollers is the concave curved groove on the inner star wheel. The above structure is installed on a rotating shaft 4. One end of the rotating shaft (left end) extends radially to form an end cover 40 of the rotating shaft, which is fastened with the inner star wheel 2 by using a bolt 5 and a nut. Thus, the above gear-type outer ring and the inner star wheel can rotate relative to each other, and the other parts in the structure are the same as those described in the technical solution according to the present invention.

In an embodiment of the present invention, an inner cylindrical surface of the outer ring has a diameter of 210 mm. The rollers have a diameter of 24.23 mm and a length of 32 mm. The external diameter at the contact point between the inner star wheel and the rollers is 162 mm. The engagement angle between the rollers and an inner/outer raceway surface is 3.75°. The clearance between two rollers is 0.02 mm. The curvature radius at the contact point between the rollers and the curved surface of the star wheel is 15 mm, and the curvature radius at the contact point between the rollers and the outer raceway is 105. According to the Hertz Theory, it can be known that, a comprehensive curvature at a contact point between the rollers and an inner surface of the outer ring is

$$Q = \frac{{R}_{L} \times {r}_{2}}{{R}_{L} - {r}_{2}} = \frac{105 \times 12.115}{105 - 12.115} = 13.7 ,$$

and a comprehensive curvature at a contact point between the rollers and an external surface of the inner star wheel is

$$Q = \frac{{R}_{L} \times {r}_{2}}{{R}_{L} - {r}_{2}} = \frac{15 \times 12.115}{15 - 12.115} = 63$$

(in which r₂ is a radius of the roller, and R_{L} is curvature radius at a contact point between the rollers and the inner/outer raceway).

Within the same space (that is, the diameter of the inner cylindrical surface of the outer ring is 210 mm), the wedge-type overrunning clutch has 44 wedge blocks, each wedge block having a width of 20.5 mm. The curvature radius at a contact point between the wedge block and the inner/outer raceway is 7.85, and the diameter of the outer surface of the inner ring is 184.18. The engagement angle α between the wedge block and the outer surface of the inner raceway is 3.4°, and the engagement angle β between the wedge block and the inner surface of the outer raceway is 2.58°. According to the Hertz Theory, it can be known that, the comprehensive curvature at the contact point between the wedge block and the inner surface of the outer raceway is

$$Q = \frac{{R}_{L} \times {r}_{2}}{{R}_{L} - {r}_{2}} = \frac{105 \times 7.85}{105 - 7.85} = 8.48 ,$$

and the comprehensive curvature at the contact point between the wedge block and the outer surface of the inner raceway is

$$Q = \frac{{R}_{L} \times {r}_{2}}{{R}_{L} + {r}_{2}} = \frac{92.09 \times 7.85}{92.09 + 7.85} = 7.23 .$$

[Sₘₐₓ]=330 kg·mm⁻² (S generally ranges from 310 to 330 kg·mm⁻²).

According to the equation:

$$M = 2 Z \cdot Q \cdot R \cdot b \cdot tg β \cdot \frac{{[ {s}_{max} ]}^{2}}{{86.1}^{2}} ,$$

in which:

M: torque transmitted by the whole clutch;

Z: number of rollers or wedge blocks;

Q: comprehensive curvature at a contact point between a single roller or wedge block and the raceway surface;

R: radius of the raceway;

b: width of a single roller or wedge block (unit: mm);

β: engagement angle between the roller or wedge block and the raceway surface.

Considering the wedge-type overrunning clutch:

On the outer raceway, it has the following result:

$$\begin{matrix}M = 2 Z \cdot Q \cdot R \cdot b \cdot tg β \cdot \frac{{[ {s}_{max} ]}^{2}}{{86.1}^{2}} \\ = 2 \times 44 \times 8.48 \times 105 \times 20.5 \times 0.045 \times \frac{{330}^{2}}{{86.1}^{2}} \\ = 1061832 Kg \cdot mm \approx 10406 ( N \cdot m )\end{matrix}$$

On the inner raceway, it has the following result:

$$\begin{matrix}M = 2 Z \cdot Q \cdot R \cdot b \cdot tg β \cdot \frac{{[ {s}_{max} ]}^{2}}{{86.1}^{2}} \\ = 2 \times 44 \times 7.23 \times 92.09 \times 20.5 \times 0.0594 \times \frac{{330}^{2}}{{86.1}^{2}} \\ = 1048082 Kg \cdot mm \approx 10271 ( N \cdot m )\end{matrix}$$

Considering the bearing-type overrunning clutch of a loader biaxial assembly:

On the outer raceway, it has the following result:

$$\begin{matrix}M = 2 Z \cdot Q \cdot R \cdot b \cdot tg β \cdot \frac{{[ {s}_{max} ]}^{2}}{{86.1}^{2}} \\ = 2 \times 24 \times 13.7 \times 105 \times 32 \times 0.065 \times \frac{{330}^{2}}{{86.1}^{2}} \\ = 2109774 Kg \cdot mm \approx 20676 ( N \cdot m )\end{matrix}$$

On the inner raceway, it has the following result:

$$\begin{matrix}M = 2 Z \cdot Q \cdot R \cdot b \cdot tg β \cdot \frac{{[ {s}_{max} ]}^{2}}{{86.1}^{2}} \\ = 2 \times 24 \times 63 \times 81 \times 32 \times 0.065 \times \frac{{330}^{2}}{{86.1}^{2}} \\ = 7484309 Kg \cdot mm \approx 73346 ( N \cdot m )\end{matrix}$$

Based on the above calculation and comparison, it can be seen that, the torque transmitted by the bearing-type overrunning clutch of the loader biaxial assembly is much larger than that transmitted by the wedge-type overrunning clutch.

In the bearing-type overrunning clutch of the loader biaxial assembly, the clearance between rollers is very small, which is only 0.02 mm. When the clutch is in engaging status, all rollers are loaded synchronously through interlocking with each other once one roller is engaged and loaded, thereby ensuring overall synchronization during working.

The above merely are some embodiments of the present invention. Any modification or variation made by those skilled in the art based on the present invention belongs to the protection scope of the present invention, and the protection scope is not limited to the disclosure of the embodiments of the present invention.

What is claimed is:

1. A bearing-type overrunning clutch structure, characterized by comprising an outer ring, an inner star wheel, and a plurality of rollers provided between the outer ring and the inner star wheel,
wherein a plurality of concave curved grooves are provided on an outer cylindrical surface of the inner star wheel along a peripheral direction, each of the concave curved grooves corresponding to one roller respectively; an outer raceway of the rollers is an inner cylindrical surface of the outer ring contacting the rollers, and an inner raceway is the concave curved grooves on the outer cylindrical surface of the inner star wheel;
the inner star wheel and the outer ring rotate relative to each other in a same direction; when a speed n2 of the inner star wheel is lower than or equal to a speed n1 of the outer ring, the rollers are wedged tightly between the inner star wheel and the outer ring, and in turn the clutch is in engaging status; and when the speed n2 of the inner star wheel is larger than the speed n1 of the outer ring, the clutch is in disengaging status.

2. The bearing-type overrunning clutch structure according to claim 1, characterized in that the outer ring is a gear-type outer ring and is provided with an annular concave groove along its peripheral direction, and the inner star wheel and the rollers matching with the inner star wheel are disposed in the annular concave groove to form a clutch structure; each of the rollers is installed in a corresponding concave curved groove on the outer cylindrical surface of the inner star wheel; the outer raceway of the rollers is an external peripheral surface of the annular concave groove at the outer ring, and the inner raceway is the concave curved grooves on the inner star wheel.

3. The bearing-type overrunning clutch structure according to claim 1 or 2, characterized in that a clearance between adjacent rollers in the bearing-type overrunning clutch is s−2r=0-0.2 mm,
in which a is a central distance between the adjacent rollers, and r is a radius of the roller;
when the clutch is in engaging status, one roller is engaged and loaded, and then all the rollers are loaded synchronously through interlocking between the rollers, thereby ensuring overall synchronization during working.

4. The bearing-type overrunning clutch structure according to claim 1 or 2, characterized in that the concave curved grooves are equidistantly distributed on the outer cylindrical surface of the inner star wheel, and have a depth L:
$$\frac{d}{10} < L < \frac{d}{2} ,$$
in which d is a diameter of the roller.

5. The bearing-type overrunning clutch structure according to claim 1 or 2, characterized in that a generating line of a concave curved surface for forming the concave curved grooves is parallel to an axis of the inner star wheel.

6. The bearing-type overrunning clutch structure according to claim 4, characterized in that a generating line of a concave curved surface for forming the concave curved grooves is parallel to an axis of the inner star wheel.

7. The bearing-type overrunning clutch structure according to claim 1 or 2, characterized in that a concave curved surface in the concave curved grooves is formed by a logarithmic spiral or arc.

8. The bearing-type overrunning clutch structure according to claim 7, characterized in that an eccentric distance e from a polar point of the logarithmic spiral or a circle center of the arc for forming the concave curved surface to a center of the roller satisfies: e>0.

9. The bearing-type overrunning clutch structure according to claim 1 or 2, characterized in that the rollers is tangent to an outer raceway surface of the gear-type outer ring or the outer ring.

10. The bearing-type overrunning clutch structure according to claim 2, characterized in that the gear-type outer ring is formed by a ring body and a plurality of gear teeth disposed at an external peripheral edge thereof, and the ring body is provided with an annular concave groove along its peripheral direction, and a notch of the annular concave groove passes through an end surface of the gear-type outer ring.
